(19) United States
(12) Patent Application Publication
(10) Pub. No.: US 2015/0165638 A1
(43) Pub. Date: Jun. 18, 2015

(54) LOG HOLDER

(71) Applicant: FOREST MASTER LTD., Tyne & Wear (GB)

(72) Inventor: Andrew Martin, Tyne & Wear (GB)

(73) Assignee: FOREST MASTER LTD., Tyne & Wear (GB)

(21) Appl. No.: 14/401,422

(22) PCT Filed: May 15, 2013
(86) PCT No.: PCT/GB2013/051246

§ 371 Date: Nov. 14, 2014

(30) Foreign Application Priority Data
May 22, 2012 (GB) 1209007.2

(51) Int. Cl. B27B 17/00

(52) U.S. Cl. CPC B27B 17/0075

(57) ABSTRACT

A log holder for holding a log, tree or other piece of wood in a raised position above the ground to enable to log, tree or other piece of wood to be cut into pieces is disclosed. Log holder comprises a support portion on which a log can be rested and a plurality of spike members each comprising at least one pointed end arranged to grip a log to be held by the log holder, each said spike member being pivotally mounted to a spike member support portion to be pivotable to positions in which the pointed ends grip a log to hold the log in a cantilevered position between the spike members and the support portion.

The present invention relates to a log holder for holding a log, tree or other piece of wood in a raised position above the ground to enable the log, tree or other piece of wood to be cut into pieces.

It is desirable to provide an apparatus to securely hold a log, felled tree or other piece of wood in a raised position to enable the log to be cut into pieces with a chainsaw or other cutting device. It is also desirable that such an apparatus is able to hold many different sizes of log, tree or piece of wood in a safe and secure manner.

EP1085966 describes a device for holding a log, felled tree or other pieces of wood. A plurality of upwardly pointing teeth is arranged on the lower part of a frame. A pendulum is pivotally mounted to the upper part of the frame and comprises a plurality of downwardly pointing teeth. In order to hold a log in a raised position, the log is rested on the upwardly pointing teeth and the pendulum is then pivoted to a position in which it grips the upper surface of the log. The log can then be lifted to a raised position in which it is cantilevered between the frame and the pendulum. This enables cutting of the log with a chain saw.

This apparatus suffers from the drawback that in order to change the size of log that can be held, the length of the pendulum must be adjusted. This is accomplished by removing the pendulum and then remounting it by passing two dowels through a different one of a plurality of sets of holes. Consequently, this apparatus is time consuming to adjust and comprises many moving parts which are prone to being misplaced or damaged.

A preferred embodiment of the present invention seeks to overcome the above disadvantages of the prior art.

According to the present invention, there is provided a log holder for holding a log, tree or other piece of wood in a raised position above the ground to enable the log, tree or other piece of wood to be cut into pieces, the log holder comprising:
a support portion on which a log can be rested;
a plurality of spike members each comprising at least one pointed end arranged to grip a log to be held by the log holder, each said spike member being pivotally mounted to a spike member support portion to be pivotable to positions in which the pointed ends grip a log to hold the log in a cantilevered position between the spike members and the support portion.

By providing a plurality of spike members each comprising at least one pointed end arranged to grip a log, wherein each said spike member is pivotally mounted to a spike member support portion, this provides the advantage that because the spike members are movable independently of one another, each spike member can move into a position around the outer circumference of a log in which it automatically grips the log to prevent the log from either pivoting about the support portion or moving from side to side. This therefore provides the advantage of a log holder that grips a log to be cut in a reliable and secure manner.

This also provides the advantage of a log holder that is straightforward to use and self-adjustable to hold logs of different sizes.

In a preferred embodiment, the log holder comprises a frame defining an aperture for receiving a log, wherein the support portion forms the lower side of the aperture and the spike member support portion forms the upper side of the aperture.

In a preferred embodiment, pushing an end of a log into the aperture pivots at least one said spike member to a position in which at least one said pointed end projects into the log if the log is released.

This provides the advantage that the action of pushing a log through the aperture causes the spike members to pivot into a position in which they automatically grip the log. As a consequence, when the user's grip is released on the log, the log settles in a cantilevered position in the log holder.

In a preferred embodiment, the spike member support portion is elongate and each said spike member is pivotally mounted at a different position along the length of the spike member support portion.

In a preferred embodiment, the length of the spike members decreases from the longest spike member being mounted at the centre of the spike member support portion to the shortest spike members being mounted towards the ends of spike member support portion.

This provides the advantage of a configuration of spike members that improves grip on the log by holding the log at different positions along its length and also helps to prevent the log moving from side to side when being held in the log holder.

In a preferred embodiment, the log holder further comprises a plurality of teeth disposed on the support portion.

This provides the advantage of increasing the grip on the log.

The frame may be foldable to decrease the size of the log holder for storage.

A preferred embodiment of the present invention will now be described by way of example only and not in any limitative sense, with reference to the accompanying drawings in which:

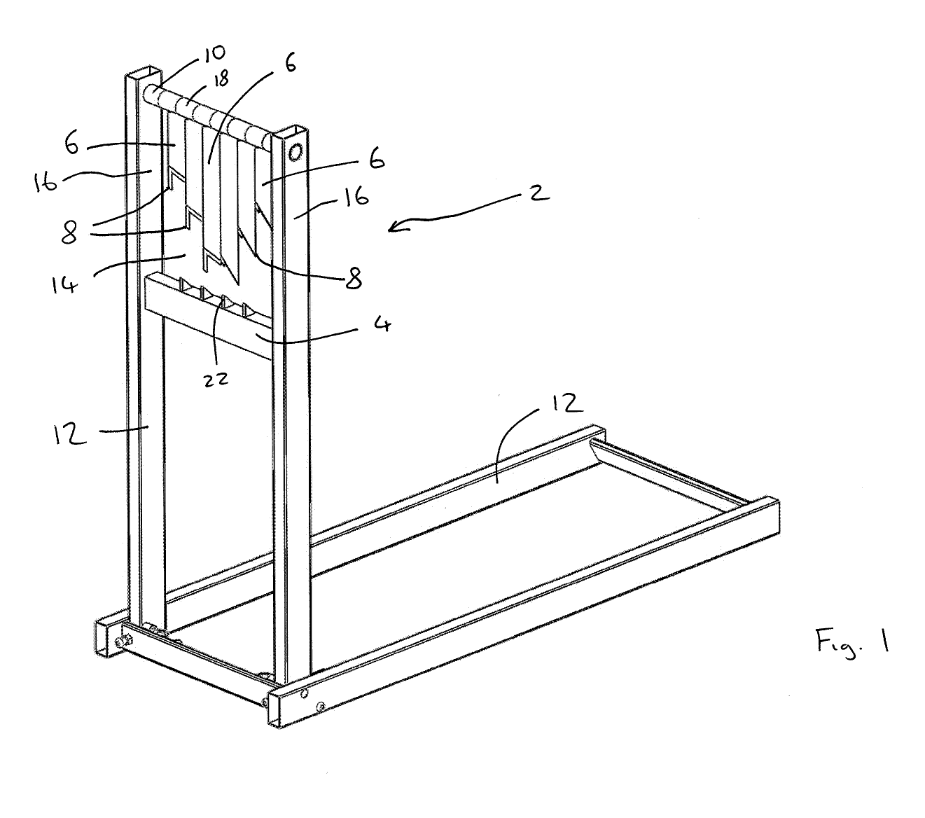

FIG. 1 is a front perspective view of a log holder embodying the present invention;

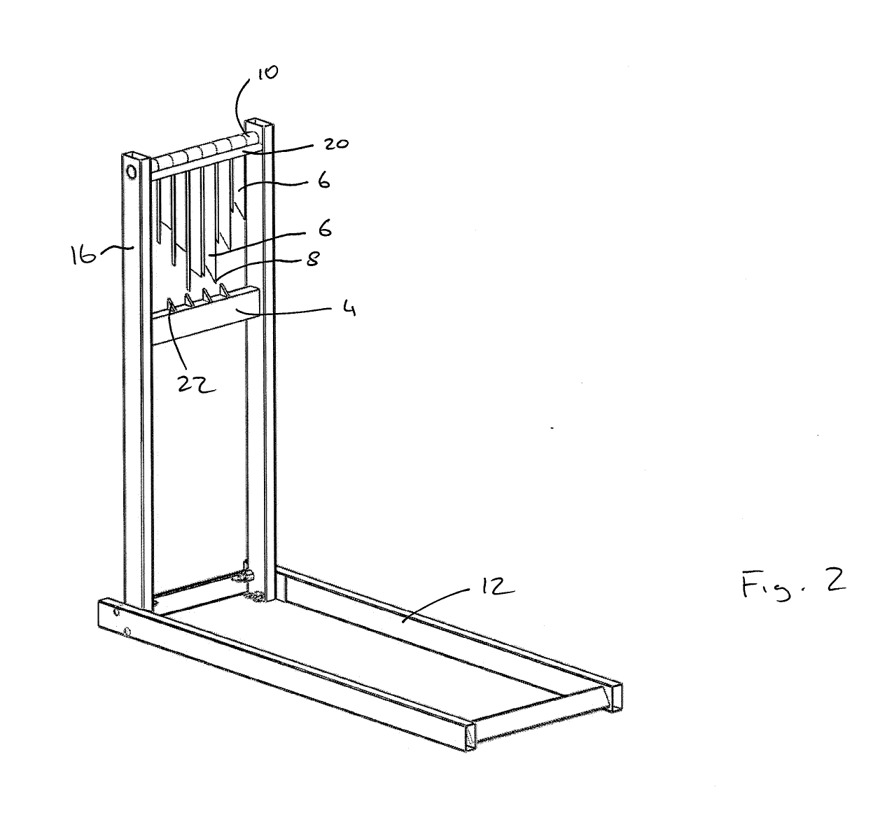

FIG. 2 is a rear perspective view of the log holder of FIG. 1;

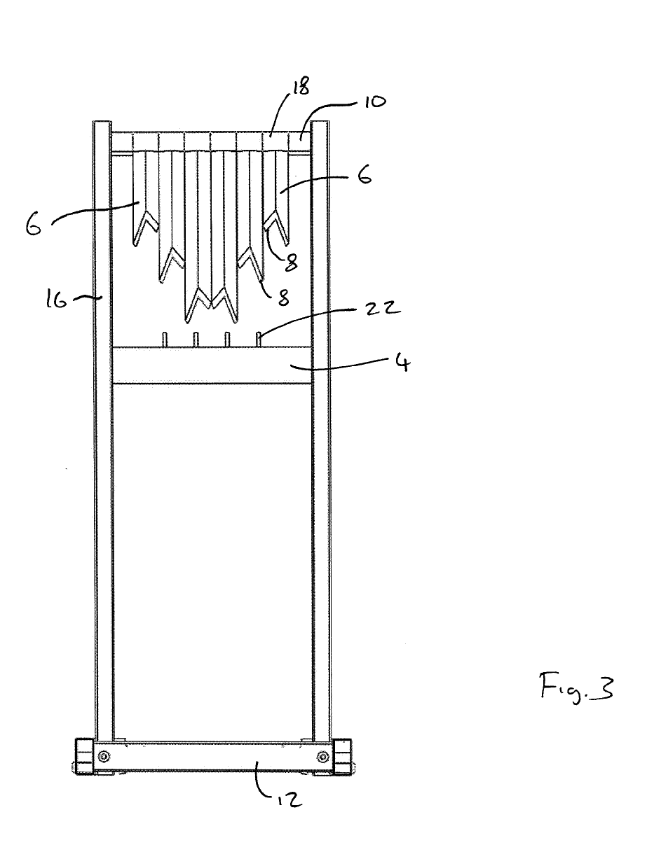

FIG. 3 is a front view of the log holder of FIG. 1;

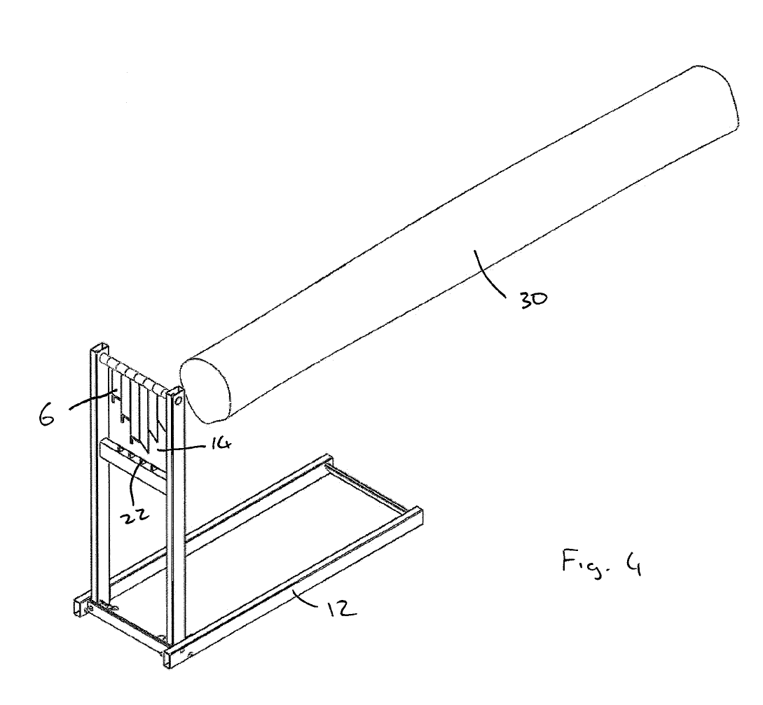

FIG. 4 is a perspective view of a log holder of FIG. 1 and a log in which the log is about to be loaded in the log holder;

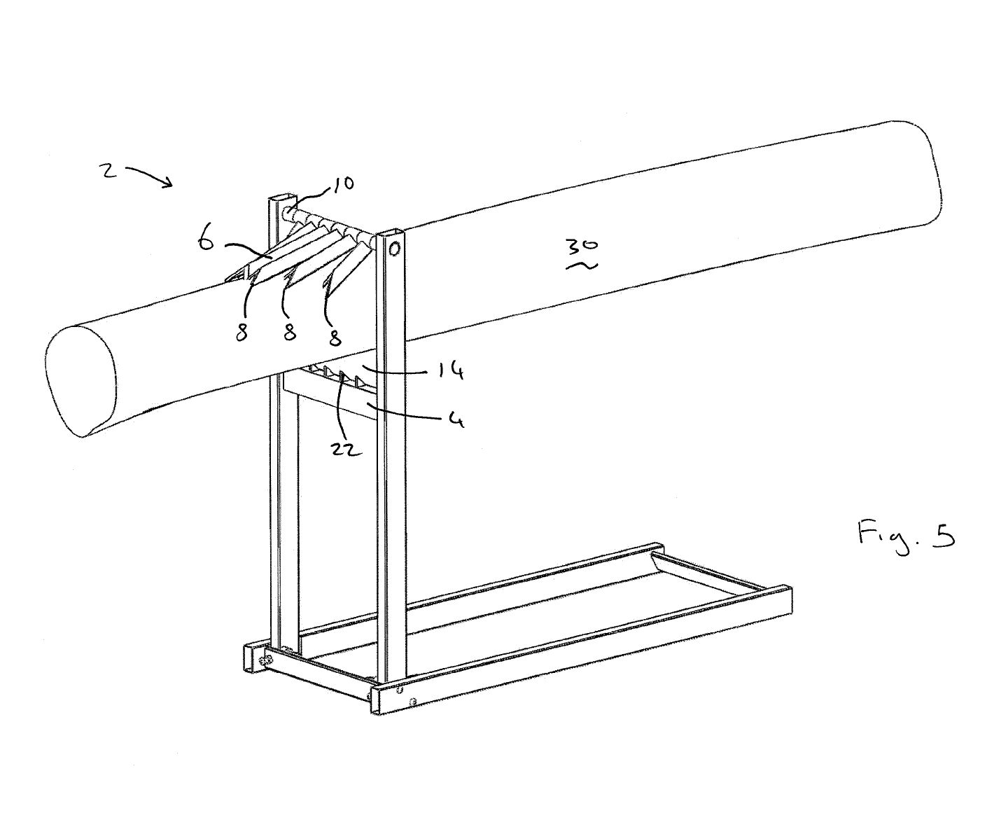

FIG. 5 is a perspective view showing the log loaded into the log holder of FIG. 4;

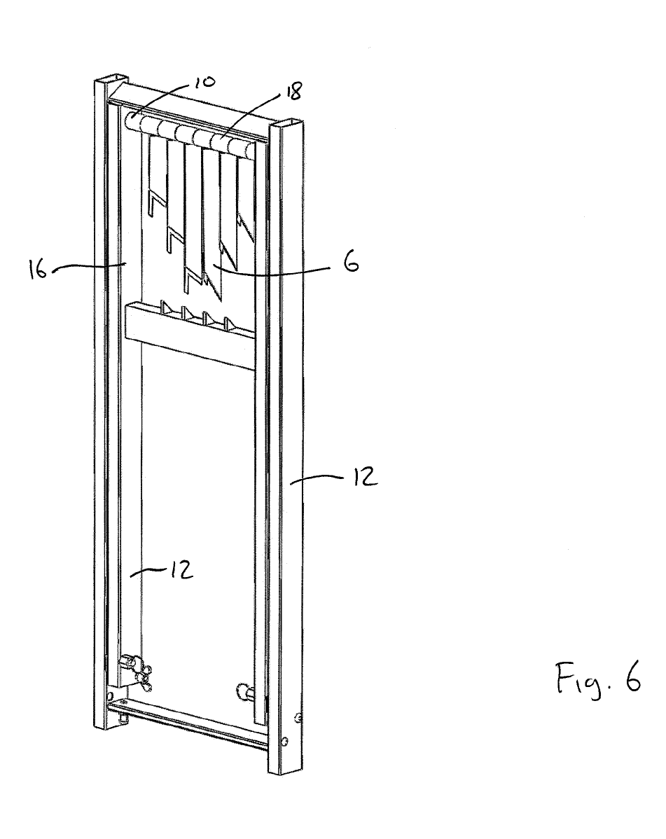

FIG. 6 is a perspective view of the log holder of FIG. 1 shown in the folded condition for storage;

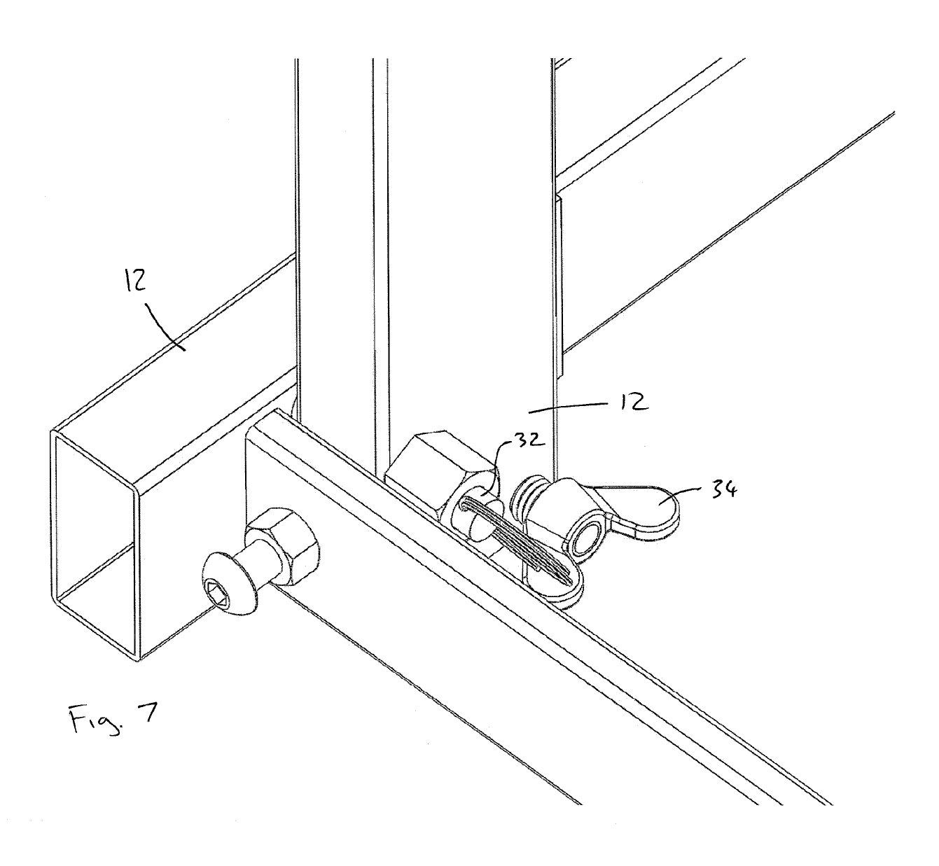

FIG. 7 is a close up view of a spring loaded pin and wing nut of the log holder of FIG. 1.

Referring to FIGS. 1 to 3, a log holder 2 for holding a log, tree or other piece of wood in a raised position above the ground to enable to log, tree or other piece of wood to be cut into pieces comprises a support portion 4 on which a log can be rested. Log holder 2 also comprises a plurality of spike members 6 each comprising at least one pointed end 8 arranged to grip a log to be held by the log holder, each said spike member being pivotally mounted to a spike member support portion 10 to be pivotable to positions in which the pointed ends 8 grip a log to hold the log in a cantilevered position between the spike members 6 and the support portion 10.

The log holder comprises a frame 12 defining an aperture 14 for receiving a log, wherein the support portion 4 forms the lower side of the aperture and the spike member support 10 forms the upper side of the aperture. A plurality of teeth 22 is disposed on the support portion 4 to grip a lower surface of a log. The sides of the aperture 14 are formed by upright portions 16. One of the upright portions 16 could be removed in an embodiment of the log holder to aid loading of a log through the aperture 14.

Spike members 6 are formed from strips of metal such as steel bent lengthwise to form a V and cut at a first end to have pointed ends 8 and attached to circular portions 18 at a second end. Circular portions 18 are mounted to spike member support portion 10 to enable the spike member 6 to pivot freely on the support member 10 in one direction. A stop bar 20 (FIG. 2) is provided on the rear of the frame to prevent the spike members 6 pivoting backwardly.

The spike member support portion 10 is an elongate tube of metal and each spike member 6 is pivotally mounted at a different position along the length of the spike member support portion 10. The length of the spike members 6 decreases from the longest spike member 6 being mounted at the centre of the support portion 10 to the shortest spike members being mounted towards the end of the spike member support portion 10. This configuration enables the log to be gripped at different points along its length and also helps to prevent the log moving from side to side when loaded in the holder.

Referring to FIGS. 4 and 5, the operation of the log holder to hold a log in a cantilevered position will now be described. Depending on the size of log 30, one or more users lifts log 30 and passes one end of the log through aperture 14. This causes the spike members to be pushed by the end of the log to pivot about spike member support portion 10 to adopt various positions around the outer circumference of log 30 in which the pointed ends 8 dig into the log 30.

When the user releases log 30, the log is held in a cantilevered position between pointed ends 8 and support portion 4. The log can then be cut with a chainsaw or other cutting means to break up the log for use as firewood.

Referring to FIGS. 6 and 7, the frame 12 can be folded for storage. The portions of frame 12 having uprights 16 comprise spring-loaded pins 32 which when pulled out enable the frame to pivot into the collapsed condition shown in FIG. 6. Wing nuts 34 are also provided to tighten the members of the frame against one another to prevent the frame pivoting when in use or when folded for storage. It is also envisaged that the upper part of the frame comprising uprights 16 could be removable for mounting to a wall.

It will be appreciated by persons skilled in the art that the above embodiment has been described by way of example only and not in any limitative sense, and that various alterations and modifications are possible without departure from the scope of the invention as defined by the appended claims.

1. A log holder for holding a log, tree or other piece of wood in a raised position above the ground to enable the log, tree or other piece of wood to be cut into pieces, the log holder comprising:
a support portion on which a log can be rested;
a plurality of spike members each comprising at least one pointed end arranged to grip a log to be held by the log holder, each said spike member being pivotally mounted to a spike member support portion to be pivotable to positions in which the pointed ends grip a log to hold the log in a cantilevered position between the spike members and the support portion.

2. A log holder according to claim 1, wherein the log holder comprises a frame defining an aperture for receiving a log, wherein the support portion forms the lower side of the aperture and the spike member support portion forms the upper side of the aperture.

3. A log holder according to claim 2, wherein pushing an end of a log into the aperture pivots at least one said spike member to a position in which at least one said pointed end projects into the log if the log is released.

4. A log holder according to claim 1, wherein the spike member support portion is elongate and each said spike member is pivotally mounted at a different position along the length of the spike member support portion.

5. A log holder according to claim 4, wherein the length of the spike members decreases from the longest spike member being mounted at the centre of the spike member support portion to the shortest spike members being mounted towards the ends of spike member support portion.

6. A log holder according to claim 1, further comprising a plurality of teeth disposed on the support portion.

7. A log holder according to claim 2, wherein the frame is foldable to decrease the size of the log holder for storage.

8. (canceled)

9. A log holder according to claim 2, wherein the spike member support portion is elongate and each said spike member is pivotally mounted at a different position along the length of the spike member support portion.

10. A log holder according to claim 3, wherein the spike member support portion is elongate and each said spike member is pivotally mounted at a different position along the length of the spike member support portion.

11. A log holder according to claim 10, wherein the length of the spike members decreases from the longest spike member being mounted at the centre of the spike member support portion to the shortest spike members being mounted towards the ends of spike member support portion.

12. A log holder according to claim 11, further comprising a plurality of teeth disposed on the support portion.
